(19) United States
(12) Patent Application Publication
(10) Pub. No.: US 2011/0063490 A1
(43) Pub. Date: Mar. 17, 2011

(54) DISPLAY APPARATUS, PORTABLE INFORMATION TERMINAL, AND DISPLAY CONTROL METHOD AND DISPLAY CONTROL PROGRAM FOR PORTABLE INFORMATION TERMINAL

(75) Inventor: Takeshi OGITA, Tokyo (JP)

(73) Assignee: SONY ERICSSON MOBILE COMMUNICATIONS JAPAN, INC., Tokyo (JP)

(21) Appl. No.: 12/815,818

(22) Filed: Jun. 15, 2010

(30) Foreign Application Priority Data
Sep. 14, 2009 (JP) 2009-211976

(51) Int. Cl. G09G 5/00; H04N 5/222

(52) U.S. Cl. 348/333.01; 345/208; 348/E05.022; 345/87

(57) ABSTRACT

A display apparatus includes: a display section including a transparent scattering layer switchable in accordance with a first control signal between a state in which incident light is transmitted in units of dots and a state in which incident light is scattered in units of dots, a transparent reflective layer switchable in accordance with a second control signal between a state in which incident light is transmitted and a state in which incident light is reflected, and a bonding layer that bonds the transparent scattering layer and the transparent reflective layer to each other; and a control signal generation section configured to generate the first and second control signals.

### BACKGROUND OF THE INVENTION

1. Field of the Invention

The present invention relates to a display apparatus including a so-called transparent display, a portable information terminal including the display apparatus, and a display control method and a display control program for the portable information terminal.

2. Description of the Related Art

In recent years, so-called transparent displays that may assume a state (display-on state) in which information is displayed on the display and a state (display-off state) in which a background is seen through the back surface side of the display have been developed. A display that uses a polymer-scattered liquid crystal (a polymer-dispersed liquid crystal or a polymer network liquid crystal), among various types of transparent displays being studied, has almost reached the level of practical use. The polymer-scattered liquid crystal scatters incident light when no voltage is applied, and allows incident light to pass through when a voltage is applied.

Japanese Unexamined Patent Application Publication No. 2003-150070 (FIG. 1) discloses a cellular phone including a display device in which a liquid crystal shutter member, in which liquid crystal molecules that change their orientation in accordance with an applied voltage are sealed, is disposed on the display surface side of a display that displays characters, images, and so forth. According to the cellular phone, characters, images, and so forth displayed on the display may be seen through the liquid crystal shutter member by applying no voltage to the liquid crystal molecules to make the liquid crystal shutter member transparent, and the liquid crystal shutter member may be used as a mirror by applying a voltage to the liquid crystal molecules to make the liquid crystal shutter member specular.

### SUMMARY OF THE INVENTION

The transparent display described above involves the following issues.

A first issue is that information displayed on the display may be very difficult to see depending on the status (color, brightness, etc.) of a background seen through the transparent display in the case where a display apparatus including the transparent display is used under various circumstances such as in the field or in a dark place, for example. That is, in the case where white characters are displayed on the display, for example, the characters may be very difficult to see when the background seen through the display is white. Also, in the case where a polymer-scattered liquid crystal is used as the transparent display in a dark surrounding environment, for example, the polymer-scattered liquid crystal may be difficult to see with less incident light and hence less scattered light.

A second issue is a privacy issue that information displayed on the transparent display may be seen also from the back surface side of the display, for example, and may be seen by others.

According to the technique disclosed in Japanese Unexamined Patent Application Publication No. 2003-150070 (FIG. 1) described above, the display is provided under the liquid crystal shutter member, and information displayed on the display may be concealed by making the liquid crystal shutter member specular to protect the privacy. In this case, however, the displayed information is also not seen from a user himself/herself. The display device disclosed in Japanese Unexamined Patent Application Publication No. 2003-150070 (FIG. 1) does not allow the background to be seen through, and thus does not function as a transparent display. Other techniques according to the related art include providing a reflective sheet on the back side of a polymer-scattered liquid crystal. However, the technique also does not provide a transparent display.

It is therefore desirable to provide a display apparatus usable as a transparent display that addresses an issue of deteriorated viewability of information displayed on the display which may occur depending on the status of a background and a privacy issue that information displayed on the display is seen not only by a user himself/herself but also by others from the back surface side of the display, a portable information terminal, and a display control method and a display control program for a portable information terminal.

According to an embodiment of the present invention, there is provided a display apparatus including: a display section including a transparent scattering layer switchable in accordance with a first control signal between a state in which incident light is transmitted in units of dots and a state in which incident light is scattered in units of dots, a transparent reflective layer switchable in accordance with a second control signal between a state in which incident light is transmitted and a state in which incident light is reflected, and a bonding layer that bonds the transparent scattering layer and the transparent reflective layer to each other; and a control signal generation section configured to generate the first and second control signals.

According to an embodiment of the present invention, there is provided a portable information terminal including: a display section including a transparent scattering layer switchable in accordance with a first control signal between a state in which incident light is transmitted in units of dots and a state in which incident light is scattered in units of dots, a transparent reflective layer switchable in accordance with a second control signal between a state in which incident light is transmitted and a state in which incident light is reflected, and a bonding layer that bonds the transparent scattering layer and the transparent reflective layer to each other, the transparent scattering layer and the transparent reflective layer being provided on a front surface side and a back surface side, respectively, of the terminal; a circumstance determination section configured to determine a circumstance of use of the terminal; and a control signal generation section configured to generate the first and second control signals in accordance with results of determination of the circumstance of use of the terminal performed by the circumstance determination section.

The transparent scattering layer of the display section may include a polymer-scattered liquid crystal layer in which a plurality of liquid crystal molecules corresponding to the respective dots are arranged in a matrix, and two transparent plate material layers sandwiching the polymer-scattered liquid crystal layer and including an electrode that supplies the first control signal to the respective liquid crystal molecules, and the first control signal may cause an axis of a desired liquid crystal molecule to be oriented in a direction of scattering incident light or to be oriented in a direction of allowing incident light to pass through. Also, the transparent reflective layer may include a shutter liquid crystal layer in which a plurality of liquid crystal molecules are arranged in a matrix, two transparent plate material layers sandwiching the shutter liquid crystal layer and including an electrode that supplies the second control signal to the respective liquid crystal molecules, a polarization plate layer disposed on an outer side of one of the transparent plate material layers, and a reflective polarization film layer disposed on an outer side of the other of the transparent plate material layers, and the second control signal may cause a polarization direction of all the liquid crystal molecules for incident light to be aligned with a specific direction that allows incident light to pass through the polarization plate layer and the reflective polarization film layer or to be aligned with a direction different from the specific direction.

According to the display apparatus of the present invention, the display section includes a transparent scattering layer switchable between a state in which incident light is transmitted in units of dots and a state in which incident light is scattered in units of dots, and a transparent reflective layer switchable between a state in which incident light is transmitted and a state in which incident light is reflected. Thus, according to the present invention, it is possible to provide a display apparatus usable as a transparent display that addresses an issue of deteriorated viewability of information displayed on the display which may occur depending on the status of a background and a privacy issue that information displayed on the display is seen not only by a user himself/herself but also by others from the back surface side of the display.

### BRIEF DESCRIPTION OF THE DRAWINGS

FIG. 1A shows an exemplary schematic external configuration of a cellular phone terminal according to an embodiment of the present invention, showing a schematic front view of the cellular phone terminal;

FIG. 1B shows an exemplary schematic external configuration of the cellular phone terminal according to the embodiment of the present invention, showing a schematic back view of the cellular phone terminal;

FIG. 1C shows an exemplary schematic external configuration of the cellular phone terminal according to the embodiment of the present invention, showing a schematic lateral view of the cellular phone terminal;

FIG. 1D shows an exemplary schematic external configuration of the cellular phone terminal according to the embodiment of the present invention, showing a schematic lateral view of the cellular phone terminal;

FIG. 1E shows an exemplary schematic external configuration of the cellular phone terminal according to the embodiment of the present invention, showing a schematic lateral view of the cellular phone terminal;

FIG. 1F shows an exemplary schematic external configuration of the cellular phone terminal according to the embodiment of the present invention, showing a schematic lateral view of the cellular phone terminal;

FIG. 2 shows a schematic configuration of a polymer-scattered liquid crystal, showing a state in which incident light is transmitted;

FIG. 3 shows a schematic configuration of the polymer-scattered liquid crystal, showing a state in which incident light is scattered;

FIG. 4 shows a schematic configuration of a shutter liquid crystal, showing a state in which incident light is transmitted;

FIG. 5 shows a schematic configuration of the shutter liquid crystal, showing a state in which incident light is reflected;

FIG. 6 shows a schematic configuration of a display device according to the embodiment including the polymer-scattered liquid crystal and the shutter liquid crystal;

FIG. 7 is a table showing the correspondence between voltage application ON/OFF control signals for the polymer-scattered liquid crystal and the shutter liquid crystal and how the display device appears (display modes) during voltage application ON/OFF control;

FIG. 8 illustrates a state in which the display device according to the embodiment is in a display mode M1;

FIG. 9 illustrates a state in which the display device according to the embodiment is in a display mode M2;

FIG. 10 illustrates a state in which the display device according to the embodiment is in a display mode M3;

FIG. 11 illustrates a state in which the display device according to the embodiment is in a display mode (privacy protection mode) M4;

FIG. 12 shows a display image with the display device according to the embodiment in the display mode M3;

FIG. 13 shows a display image with the display device according to the embodiment in the display mode (privacy protection mode) M4;

FIG. 14 is a block diagram showing a schematic internal configuration of a cellular phone terminal according to the embodiment; and

FIG. 15 is a flowchart of a process for automatically setting the display mode to the privacy protection mode in the cellular phone terminal according to the embodiment.

### DESCRIPTION OF THE PREFERRED EMBODIMENTS

An embodiment of the present invention will be described below with reference to the drawings.

In the embodiment, a cellular phone terminal equipped with a transparent display function is used as an example of a display apparatus, a portable information terminal, and a display control method and a display control program for a portable information terminal according to the present invention. It should be understood that the description made below in relation to the embodiment is merely illustrative and that the present invention is not limited thereto.

### [Schematic External Configuration of Cellular Phone Terminal]

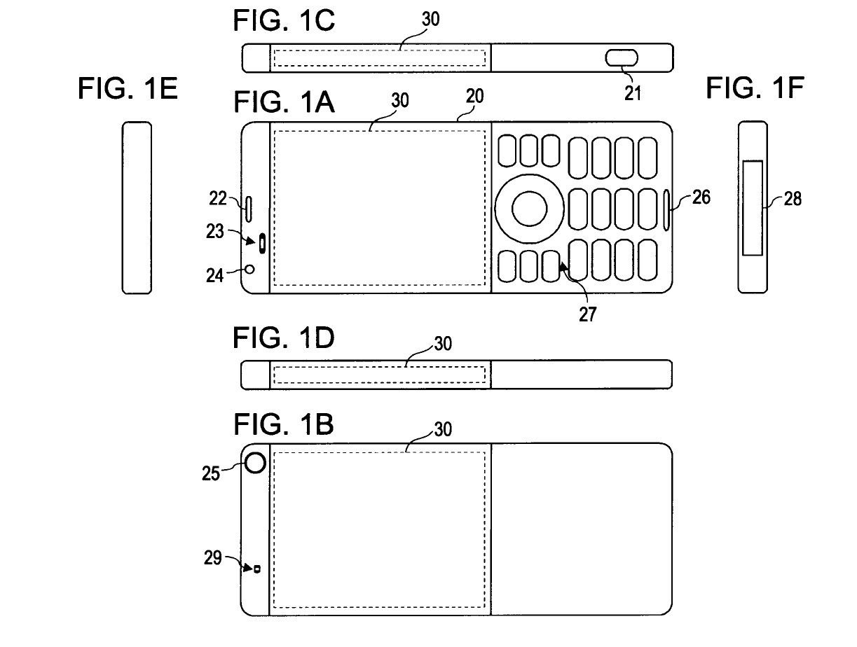

FIGS. 1A to 1F show an exemplary schematic external configuration of a cellular phone terminal 20 according to the embodiment. FIG. 1A is a schematic front view, FIG. 1B is a schematic back view, and FIGS. 1C to 1F are each a schematic lateral view, respectively, of the cellular phone terminal 20 according to the embodiment. Respective devices provided with a reference numeral in FIGS. 1A to 1F are some of all the devices provided in the cellular phone terminal 20. It is a matter of course that the cellular phone terminal 20 according to the embodiment is provided with various other devices provided in normal high-function cellular phone terminals, although not shown in FIGS. 1A to 1F.

In the cellular phone terminal 20 according to the embodiment shown in FIGS. 1A to 1F, a key device section 27 including key buttons such as numeric keys, call start/end keys, arrow keys, a clear key, and a mail key, a receiver speaker (receiver) 22, a transmitter microphone 26, a lens 24 of a sub camera device (in-camera), a display device 30 to be described later, a proximity sensor 23, an electrostatic sensor and a temperature sensor (not shown), and so forth are disposed on a housing front surface side shown in FIG. 1A.

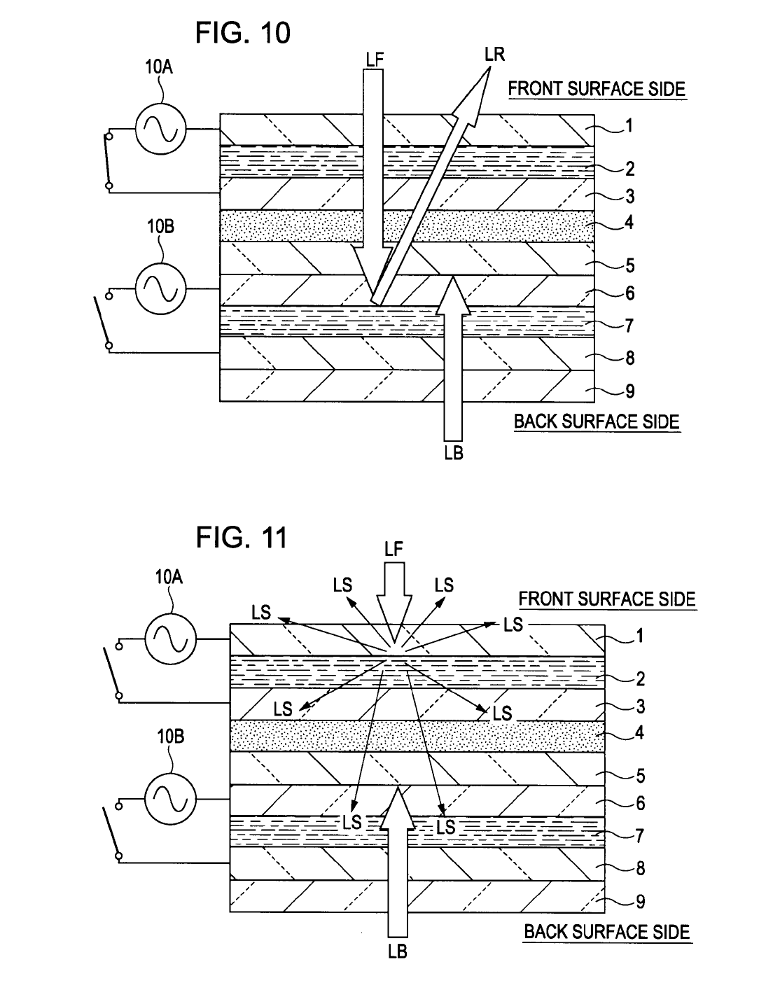

In the cellular phone terminal 20 according to the embodiment, also, a lens 25 of a main camera device and an infrared ray sensor 29 to be described later are provided on a housing back surface side shown in FIG. 1B. An interface connector 28 is provided on a housing lateral surface side shown in FIG. 1F. A shutter button 21 is provided on a housing lateral surface side shown in FIG. 10.

The key device section 27, the receiver speaker (receiver) 22, the transmitter microphone 26, the lenses 25 and 24 of the camera devices, and the interface connector 28 are the same as those provided in normal cellular phone terminals, and therefore are not described herein. The proximity sensor 23, the infrared ray sensor 29, the electrostatic sensor, and the temperature sensor will be described in detail later.

In the cellular phone terminal 20 according to the embodiment, the display device 30 has a function of displaying images, characters, symbols, and so forth on its display surface. In the case of the embodiment, the display device 30 is formed, for example, from a polymer-scattered liquid crystal and a shutter liquid crystal as described later, and also has a function of becoming transparent so that the housing front surface side is viewable from the housing back surface side and vice versa, a function of making the display content viewable from both the housing front surface side and the housing back surface side, a function of becoming substantially specular when seen from the housing front surface side, and a function of making the display content viewable from only the housing front surface side, the functions being appropriately switchable between each other.

Before describing each function of the display device 30, the schematic configuration of the polymer-scattered liquid crystal and the shutter liquid crystal will be described.

### [Schematic Configuration of Polymer-Scattered Liquid Crystal]

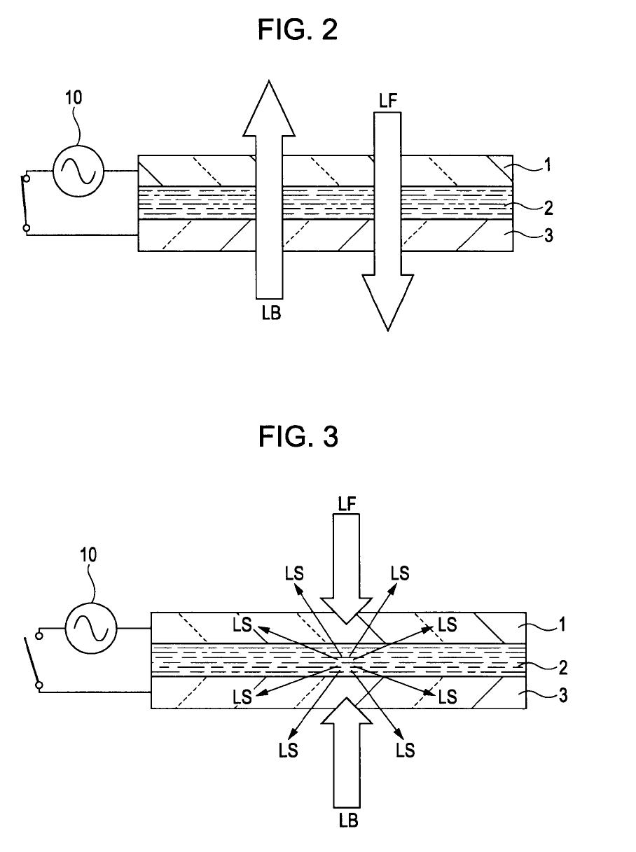

FIGS. 2 and 3 show a schematic configuration of the polymer-scattered liquid crystal.

As shown in FIGS. 2 and 3, the polymer-scattered liquid crystal has a structure in which a polymer-scattered liquid crystal layer 2 in which a large number of liquid crystal molecules corresponding to display dots are arranged in a matrix is sandwiched between two transparent plate material layers 1 and 3 made of glass or the like. One of the two transparent plate material layers 1 and 3 is disposed on the housing front surface side shown in FIG. 1A and the other is disposed on the housing back surface side shown in FIG. 1B so as to be seen from the outer side. The transparent plate material layers 1 and 3 are provided with an electrode corresponding to each liquid crystal molecule. A control signal for driving the axis of a liquid crystal molecule is sent from a control signal generator 10 via the electrode to orient the axis of a desired liquid crystal molecule in the direction of scattering incident light or in the direction of allowing incident light to pass through.

In the case where the axis of a liquid crystal molecule is oriented in the direction of allowing incident light to pass through in the polymer-scattered liquid crystal, both incident light LF from the housing front surface side and incident light LB from the housing back surface side are allowed to pass through to the other side as shown in FIG. 2. The polymer-scattered liquid crystal in this state becomes transparent so that the housing front surface side is viewable from the housing back surface side and vice versa. On the other hand, in the case where the axis of a desired liquid crystal molecule is oriented in the direction of scattering light (LS), a plurality of liquid crystal molecules related to the scattering make it possible to display images, characters, symbols, and so forth such that the display content is seeable from both the housing front surface side and the housing back surface side as shown in FIG. 3. In the example shown in FIGS. 2 and 3, the axis of a liquid crystal molecule is oriented in the direction of allowing incident light to pass through when the control signal generator 10 applies a voltage (ON), and the axis of the liquid crystal molecule is oriented in the direction of scattering incident light when the control signal generator 10 applies no voltage (OFF).

### [Schematic Configuration of Shutter Liquid Crystal]

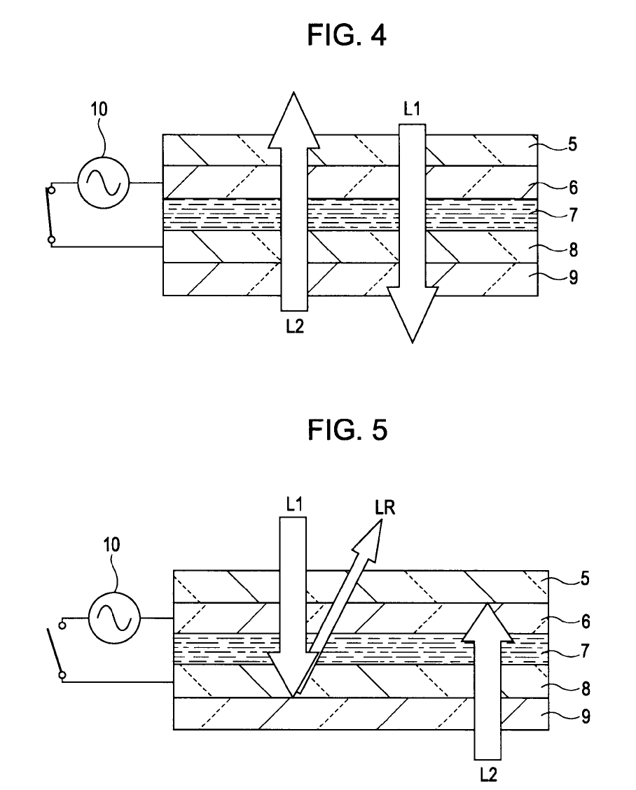

FIGS. 4 and 5 show a schematic configuration of the shutter liquid crystal.

As shown in FIGS. 4 and 5, the shutter liquid crystal has a structure in which a shutter liquid crystal layer 7 in which a large number of liquid crystal molecules are arranged in a matrix is sandwiched between two transparent plate material layers 6 and 8 made of glass or the like, a polarization plate layer 5 is provided on a side of the transparent plate material layer 6 opposite the shutter liquid crystal layer 7, and a reflective polarization film layer 9 is provided on a side of the transparent plate material layer 8 opposite the shutter liquid crystal layer 7. The polarization plate layer 5 is disposed on the housing front surface side shown in FIG. 1A and the reflective polarization film layer 9 is disposed on the housing back surface side shown in FIG. 1B so as to be seen from the outer side. The transparent plate material layers 6 and 8 are provided with an electrode corresponding to each liquid crystal molecule. A control signal for driving the liquid crystal polarization surfaces is sent from the control signal generator 10 via the electrodes to control the polarization direction of the liquid crystal molecules. In the case of the shutter liquid crystal, the polarization plate layer 5 allows only light components of incident light in a specific polarization direction to pass through, and the reflective polarization film layer 9 is transparent to only light components in a specific polarization direction and reflects light components in other polarization directions. The specific polarization direction of the polarization plate layer 5 and the specific polarization direction of the reflective polarization film layer 9 are substantially the same as each other.

In the case where the polarization direction of the shutter liquid crystal layer 7 is aligned with a specific direction matching the specific polarization direction of the polarization plate layer 5 and the reflective polarization film layer 9 in the shutter liquid crystal, both incident light L1 from the housing front surface side and incident light L2 from the housing back surface side are allowed to pass through to the other side as shown in FIG. 4. This allows the shutter liquid crystal to become transparent so that the housing front surface side is viewable from the housing back surface side and vice versa. On the other hand, in the case where the polarization direction of the shutter liquid crystal layer 7 is aligned with a direction different from the specific polarization direction of the polarization plate layer 5 and the reflective polarization film layer 9 in the shutter liquid crystal, incident light L1 from the housing front surface side is reflected (LR) by the reflective polarization film layer 9 and incident light L2 from the housing back surface side is blocked by the polarization plate layer 5 so as not to be output to the housing front surface side as shown in FIG. 5. In the example shown in FIGS. 4 and 5, the polarization direction of the liquid crystal molecules is aligned with the specific direction when the control signal generator 10 applies a voltage (ON), and the polarization direction of the liquid crystal molecules is aligned with a direction different from the specific direction when the control signal generator 10 applies no voltage (OFF).

### [Schematic Configuration of Display Device According to Embodiment]

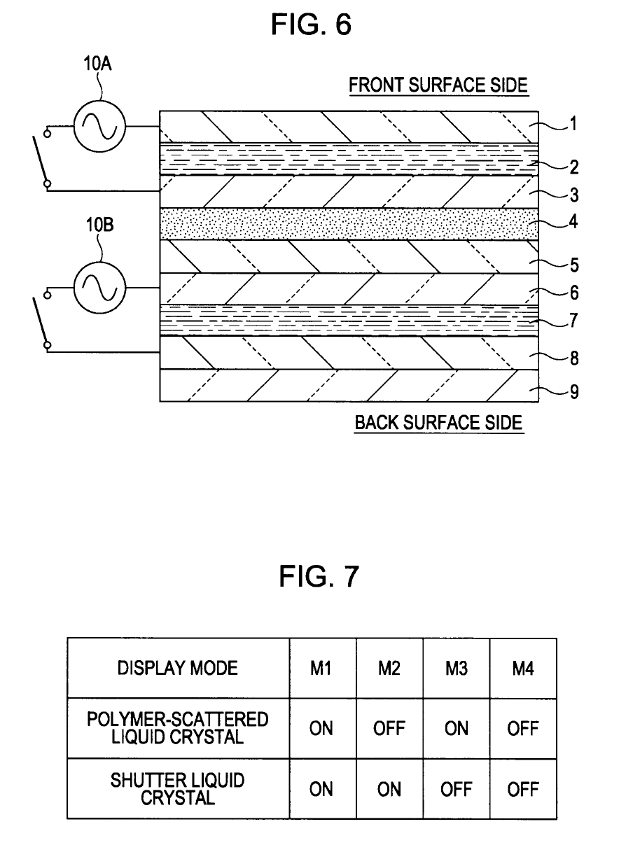

FIG. 6 shows a schematic configuration of a main portion of the display device according to the embodiment formed using the polymer-scattered liquid crystal illustrated in FIGS. 2 and 3 and the shutter liquid crystal illustrated in FIGS. 4 and 5 described above.

As shown in FIG. 6, the display device according to the embodiment has a structure in which the polymer-scattered liquid crystal and the shutter liquid crystal are bonded to each other via a bonding sheet layer 4. That is, the display device according to the embodiment includes the transparent plate material layer 1, the polymer-scattered liquid crystal layer 2, the transparent plate material layer 3, the bonding sheet layer 4, the polarization plate layer 5, the transparent plate material layer 6, the shutter liquid crystal layer 7, the transparent plate material layer 8, and the reflective polarization film layer 9, which are disposed in this order with the transparent plate material layer 1 disposed on the housing front surface side shown in FIG. 1A and with the reflective polarization film layer 9 disposed on the housing back surface side shown in FIG. 1B so as to be seen from the outer side.

The transparent plate material layers 1 and 3 are provided with an electrode corresponding to each liquid crystal molecule of the polymer-scattered liquid crystal layer 2. A control signal for driving the axis of a liquid crystal molecule is sent from a control signal generator 10A via the electrode to orient the axis of a desired liquid crystal molecule in the direction of scattering incident light or in the direction of allowing incident light to pass through.

The transparent plate material layers 6 and 8 are provided with an electrode corresponding to each liquid crystal molecule of the shutter liquid crystal layer 7. A control signal for driving the liquid crystal polarization surfaces is sent from a control signal generator 10B via the electrodes to control the polarization direction of the liquid crystal molecules.

In the embodiment, the polymer-scattered liquid crystal and the shutter liquid crystal are bonded to each other via the bonding sheet layer 4 because the presence of an air layer between the transparent plate material layer 3 of the polymer-scattered liquid crystal and the polarization plate layer 5 of the shutter liquid crystal would refract light at the interface between the transparent plate material layer 3 and the air layer and at the interface between the polarization plate layer 5 and the air layer to cause a loss of light and deteriorate the transmittance and the viewability. That is, the bonding sheet layer 4 is formed from a material having a refractive index that is the same as or very close to the refractive index of the material forming the transparent plate material layer 3 and the polarization plate layer 5. Providing the bonding sheet layer 4 substantially eliminates refraction of light and prevents a loss of light and deterioration of the transmittance and the viewability.

[Control Signals from Control Signal Generator and How Display Device Appears]

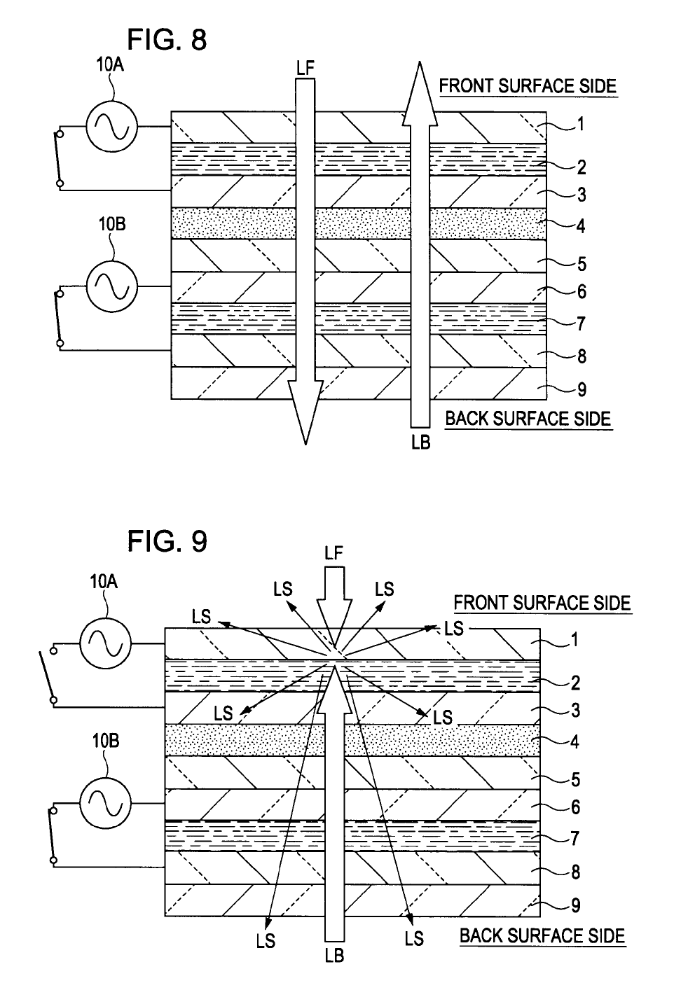

FIG. 7 is a table showing the correspondence between voltage application ON/OFF control signals for the polymer-scattered liquid crystal and the shutter liquid crystal and how the display device appears (display modes) during voltage application ON/OFF control. FIGS. 8 to 11 show how the display device transmits, scatters, or reflects incident light in each display mode shown in the correspondence table of FIG. 7.

In the case of a display mode M1 of FIG. 7, in which the polymer-scattered liquid crystal is applied with a voltage (ON) and the shutter liquid crystal is applied with a voltage (ON), the axis of the liquid crystal molecule is oriented in the direction of allowing incident light to pass through in the polymer-scattered liquid crystal portion, and the polarization direction of the shutter liquid crystal layer 7 is aligned with the specific direction in the shutter liquid crystal portion. In this case, in the display device according to the embodiment, both incident light LF from the housing front surface side and incident light LB from the housing back surface side are allowed to pass through to the other side as shown in FIG. 8. This allows the display device to become transparent so that the housing front surface side is viewable from the housing back surface side and vice versa.

In the case of a display mode M2 of FIG. 7, in which the polymer-scattered liquid crystal is applied with no voltage (OFF) but the shutter liquid crystal is applied with a voltage (ON), the axis of the liquid crystal molecule is oriented in the direction of scattering incident light (LS) in the polymer-scattered liquid crystal portion, and the polarization direction of the shutter liquid crystal layer 7 is aligned with the specific direction in the shutter liquid crystal portion. In this case, in the display device according to the embodiment, it is possible to display images, characters, symbols, and so forth on the polymer-scattered liquid crystal portion such that the display content is seeable from both the housing front surface side and the housing back surface side as shown in FIG. 9.

In the case of a display mode M3 of FIG. 7, in which the polymer-scattered liquid crystal is applied with a voltage (ON) but the shutter liquid crystal is applied with no voltage (OFF), the axis of a liquid crystal molecule is oriented in the direction of allowing incident light to pass through in the polymer-scattered liquid crystal portion, and the polarization direction of the shutter liquid crystal layer 7 is aligned with a direction different from the specific direction in the shutter liquid crystal portion. In this case, in the display device according to the embodiment, incident light LF from the housing front surface side is reflected by the reflective polarization film layer 9 and incident light LB from the housing back surface side is blocked by the polarization plate layer 5 so as not to be output to the housing front surface side as shown in FIG. 10. That is, in the case of the display mode M3, light reflected by the reflective polarization film layer 9 is seeable from the housing front surface side, but not seeable from the housing back surface side.

In the case of a display mode M4 of FIG. 7, in which both the polymer-scattered liquid crystal and the shutter liquid crystal are applied with no voltage (OFF), the axis of the liquid crystal molecule is oriented in the direction of scattering incident light (LS) in the polymer-scattered liquid crystal portion, and the polarization direction of the shutter liquid crystal layer 7 is aligned with a direction different from the specific direction in the shutter liquid crystal portion. In this case, in the display device according to the embodiment, it is possible to display images, characters, symbols, and so forth on the polymer-scattered liquid crystal portion such that the display content is seeable from only the housing front surface side and incident light LB from the housing back surface side is blocked by the polarization plate layer 5 so as not to be output to the housing front surface side as shown in FIG. 11. That is, in the case of the display mode M4, the display content is seeable from the housing front surface side, but not seeable from the housing back surface side. In the embodiment, the display mode M4 is appropriately referred to as a “privacy protection mode”.

### [Display Image]

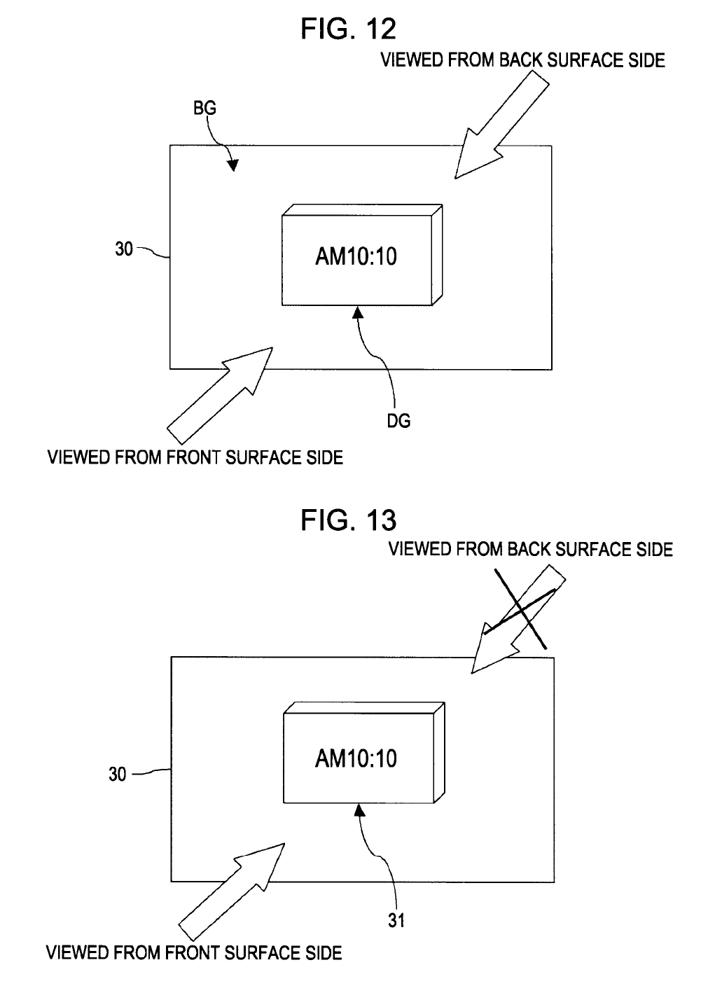

FIGS. 12 and 13 show exemplary display images on the display device according to the embodiment of the present invention.

In the embodiment, voltage application to each of the liquid crystal molecules of the polymer-scattered liquid crystal is individually turned on and off in accordance with a control signal to enable the liquid crystal molecules to make a dot representation. For the shutter liquid crystal, voltage application to all the liquid crystal molecules is collectively turned on and off.

FIG. 12 shows a display image in the case of the display mode M3 of FIG. 7. In the example of FIG. 12, voltage application to the shutter liquid crystal is turned off, and liquid crystal molecules of the polymer-scattered liquid crystal corresponding to respective dots forming an image DG are applied with a voltage (ON) and the other liquid crystal molecules of the polymer-scattered liquid crystal are applied with no voltage (OFF). Thus, in the example of FIG. 12, a background BG, together with the image DG, is seen from both the housing front surface side and the housing back surface side.

FIG. 13 shows a display image in the case of the display mode (privacy protection mode) M4 of FIG. 7. In the example of FIG. 13, liquid crystal molecules of the polymer-scattered liquid crystal corresponding to respective dots forming an image DG are applied with a voltage (ON) and the other liquid crystal molecules of the polymer-scattered liquid crystal are applied with no voltage (OFF), and voltage application to the shutter liquid crystal is turned on. Thus, in the example of FIG. 13, the image DG is seeable from the housing front surface side, but not seeable from the housing back surface side. That is, in this case, the display content is not seen at all from the housing back surface side to protect the secrecy of the display content. Also in this case, the display content is very easy to see from the housing front surface side with a background on the housing back surface side not seen through the display content and with a reflective surface formed on the housing back surface side of the polymer-scattered liquid crystal, although the background is not seeable from the housing front surface side.

### [Schematic Internal Configuration of Cellular Phone Terminal]

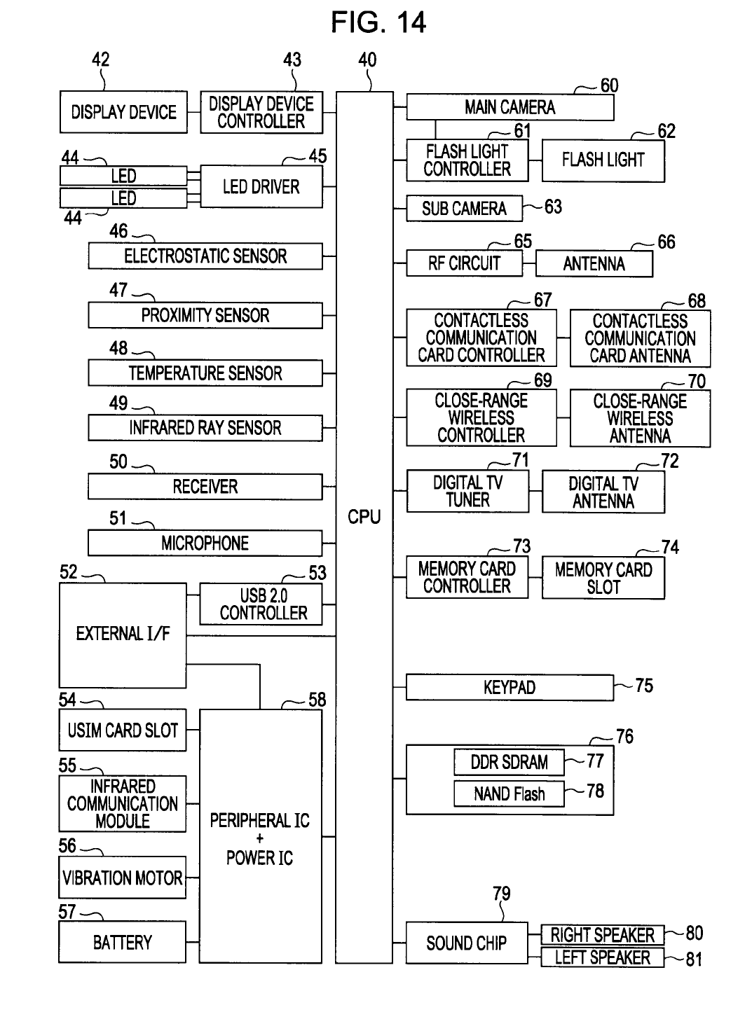

FIG. 14 shows a schematic internal configuration of the cellular phone terminal 20 according to the embodiment.

In FIG. 14, a display device 42 corresponds to the display device 30 described above in which the polymer-scattered liquid crystal and the shutter liquid crystal according to the embodiment described above are bonded to each other. A display device controller 43 is a device controller that controls operation, display, and so forth of the display device 42.

LEDs (light emitting diodes) 44 are various illumination light sources provided in the cellular phone terminal according to the embodiment such as an incoming lamp and an illumination lamp in the key device section 27 shown in FIG. 1A, for example. An LED driver 45 controls driving of the plurality of LEDs 44.

An electrostatic sensor 46 detects variations in capacitance. In the case of the cellular phone terminal 20 according to the embodiment, the electrostatic sensor 46 is disposed on the housing front surface side on which the key device section 27 shown in FIG. 1A is provided, for example in the vicinity of the receiver 22. The electrostatic sensor 46 is adapted to detect that an ear or a part of the face of the user is in contact with the electrostatic sensor 46 when the user is engaged in a call with his/her ear etc. put on the receiver 22, for example. In the case of the embodiment, in particular, the electrostatic sensor 46 is adapted to detect that the ear or a part of the face is in contact for a specific amount of area or more.

A proximity sensor 47 is formed by an ultrasonic sensor or an optical position sensor, and corresponds to the proximity sensor 23 of FIG. 1A. An ultrasonic sensor detects the distance to an object by emitting ultrasonic waves and measuring the arrival time of the ultrasonic waves reflected by the object. An optical position sensor detects the distance to an object by emitting light and measuring the incident angle of the light reflected by the object. In the case of the cellular phone terminal 20 according to the embodiment, the proximity sensor 47 is disposed on the housing front surface side on which the key device section 27 shown in FIG. 1A is provided, for example in the vicinity of the receiver 22. The proximity sensor 44 is adapted to detect that an ear or a part of the face of the user is proximate when the user is engaged in a call with his/her ear etc. put on the receiver 22, for example. In the case of the embodiment, in particular, the proximity sensor 47 is adapted to detect that the ear or a part of the face is close to the cellular phone terminal 20 within a specific distance from the cellular phone terminal 20.

A temperature sensor 48 detects the temperature of a surface or a vicinity of the cellular phone terminal. In the case of the cellular phone terminal 20 according to the embodiment, the temperature sensor 48 is disposed on the housing front surface side on which the key device section 27 shown in FIG. 1A is provided. The temperature sensor 48 is adapted to detect a temperature rise caused when an ear or a part of the face of the user contacts the cellular phone terminal 20 when the user is engaged in a call with his/her ear etc. put on the receiver 22, for example. In the case of the embodiment, in particular, the temperature sensor 48 is adapted to detect a temperature rise up to a specific temperature, such as a body temperature, or more.

An infrared ray sensor 49 corresponds to the infrared ray sensor 29 of FIG. 1B, and detects an infrared ray. In the case of the cellular phone terminal 20 according to the embodiment, the infrared ray sensor 49 is disposed on the housing back surface side on which the lens of the main camera is provided, for example. The infrared ray sensor 49 is adapted to detect an infrared ray emitted from a human body surface or the like to the housing back surface side of the cellular phone terminal 20 according to the embodiment.

A receiver 50 is equivalent to the receiver 22 of FIG. 1A. The receiver 50 is a speaker that outputs a received sound when a voice call is being made on the cellular phone terminal according to the embodiment.

A microphone 51 is equivalent to the microphone 26 of FIG. 1A. The microphone 51 is a sound input device that is used to input a sound to be transmitted when a voice call is being made on the cellular phone terminal according to the embodiment.

An external interface (I/F) 52 includes an external connector of various types and an external connection section that performs signal transfer with the external connector. The external connector includes a connector according to a so-called USB 2.0 (Universal Serial Bus 2.0) standard. Therefore, the cellular phone terminal according to the embodiment also includes a USB 2.0 controller 53.

A USIM card slot 54 is an IC card slot that receives a so-called USIM (Universal Subscriber Identity Module) card storing subscriber information (contractor information) and so forth.

An infrared communication module 55 is a communication device that communicates information using an infrared ray.

A vibration motor 56 is a so-called vibrator that generates vibration in the cellular phone terminal according to the embodiment.

A battery 57 is a power source that supplies electric power to be used by the respective sections of the cellular phone terminal according to the embodiment.

A peripheral IC+power IC 58 is connected to the USIM card slot 54, the infrared communication module 55, the vibration motor 56, the battery 57, and the external interface 52 to perform control and signal processing for the respective sections and to control power supply from the battery 57.

A main camera 60 corresponds to the main camera device of FIG. 1B, and includes an imaging optical system such as a camera lens, an imaging element (imaging device), and so forth. A flash (flash light) 62 is a light source lamp that emits fill light when the main camera 60 performs capturing. A flash light controller 61 controls light emission performed by the flash 62 in conjunction with the capturing performed by the main camera 60.

A sub camera 63 corresponds to the sub camera device described above, and is provided separately from the main camera 60. The sub camera 63 is used to capture an image of the user for himself/herself or capture an image of the user during a video call, for example.

An RF circuit 65 is a wireless communication circuit used when the cellular phone terminal according to the embodiment communicates with a base station of a cellular phone network. An antenna 66 is a wireless communication antenna used when the cellular phone terminal according to the embodiment communicates wirelessly with a base station.

A contactless communication card controller 67 performs various control and signal processing during signal communication with a contactless communication IC card through a so-called electromagnetic induction scheme. A contactless communication card antenna 68 is an antenna for contactless communication through the electromagnetic induction scheme.

A close-range wireless controller 69 performs various control and signal processing for close-range wireless communication through a so-called Bluetooth (registered trademark) scheme, for example. A close-range wireless antenna 70 is an antenna for close-range wireless communication.

A digital TV tuner 71 is a tuner for so-called digital television broadcasting. A digital TV antenna 72 is an antenna that receives radio waves of the digital television broadcasting.

A memory card slot 74 is a slot that removably receives an external memory card such as a so-called SD (Secure Digital) card, for example. A memory card controller 73 performs control and signal processing for writing/reading of data into/from a memory card loaded in the memory card slot 74.

A keypad 75 corresponds to the key device section 27 described above. The keypad 75 includes various keys and various buttons such as numeric keys, arrow keys, and a shutter button provided in the cellular phone terminal according to the embodiment, and generates a key/button output signal when such keys and buttons are operated by the user. The shutter button 21 of FIG. 1C is one of the buttons belonging to the keypad 75.

An internal memory 76 includes a DDR SDRAM (Double Data Rate SDRAM) 77 and a NAND-type flash memory 78, for example. The NAND-type flash memory 78 stores a program for an OS (Operating System), a control program for a CPU 40 to control the respective sections, a control program for the display device according to the present invention, various application programs, compression-encoded data contents such as musical pieces, moving images, and still images, various setting values, font data, various dictionary data, model information, terminal identification information, and so forth. The DDR SDRAM 77 serves as a work area for the CPU 40 to perform various data processing and computation, and stores data any time.

A sound chip 79 is an IC for signal processing such as music playback, for example. A right speaker 80 and a left speaker 81 for stereo sound output are connected to the sound chip 79 via an amplifier (not shown).

The CPU (Central Processing Unit) 40 performs communication control, sound processing and control, image processing and control, camera capture control, and various other signal processing and control for the respective sections. The CPU 40 also executes various control programs and application programs stored in the internal memory 76, and processes various data accompanying the programs. In the case of the embodiment, in particular, the CPU 40 executes the display control program according to the present invention to perform display control for each display mode of the display device described above, automatic control of the display mode based on detection outputs from the various sensors to be described later, and so forth.

It is a matter of course that the cellular phone terminal according to the embodiment additionally includes various constituent elements provided in general cellular phone terminals, although not shown in FIG. 14.

[Display Control according to Display Mode (Automatic Setting to Privacy Protection Mode)]

The cellular phone terminal according to the embodiment not only allows the user to manually set the display mode described above but also enables automatic setting of the display mode according to the result of detecting the circumstance of use of the cellular phone terminal. Automatic setting of the display mode may be performed by, for example, setting the display mode to the privacy protection mode (M4) in accordance with the circumstance of use of the cellular phone terminal, which prevents a privacy issue that information displayed on the display is seen by others from the back surface side of the display.

Information displayed on the display should not be seen from the back surface side of the display in circumstances of use where a person stays on the housing back surface side of the cellular phone terminal (first use case), where the user is engaged in a call with the cellular phone terminal put on his/her ear (second use case), and where the user is seeing a display content that he/she does not want others to see (third use case), for example. It should be understood that these use cases are merely exemplary and that the present invention is not limited thereto.

In the embodiment, when the main camera device (25, 60) provided on the housing back surface side captures an image and a face image of a person is recognized in the image using a so-called face image detection technology, for example, it is determined that a person stays on the housing back surface side of the cellular phone terminal (first use case) so that the display mode is automatically switched to the privacy protection mode M4.

Also, when the infrared ray sensor (29, 49) provided on the housing back surface side detects an infrared ray and it is determined that the detected infrared ray is within a threshold range determined in correspondence with infrared rays emitted from human bodies, for example, it is determined that a person stays on the housing back surface side of the cellular phone terminal (first use case) so that the display mode is automatically switched to the privacy protection mode M4.

Also in the embodiment, when the electrostatic sensor 46 provided in the vicinity of the receiver 22 detects a contact with an ear or a face and it is determined that the detected contact area is within a certain threshold area range determined in advance, for example, it is determined that the user is engaged in a call with the cellular phone terminal put on his/her ear (second use case) so that the display mode is automatically switched to the privacy protection mode M4.

Also, when the proximity sensor (23, 47) provided in the vicinity of the receiver 22 detects an approach to an ear or a face and it is determined that the detected distance is within a certain threshold distance determined in advance, for example, it is determined that the user is engaged in a call with the cellular phone terminal put on his/her ear (second use case) so that the display mode is automatically switched to the privacy protection mode M4.

Also, when the temperature sensor (48) provided in the vicinity of the receiver 22 detects a temperature and it is determined that the detected temperature is within a certain threshold temperature range around body temperatures (for example, 30 to 36 degrees), for example, it is determined that the user is engaged in a call with the cellular phone terminal put on his/her ear (second use case) so that the display mode is automatically switched to the privacy protection mode M4.

Also, when a browser application program, a mail application program, or a viewer application program for moving images or still images is being run and the content being displayed on the display by such an application program has been set in advance as a content to be protected for the security of privacy, or simply when such an application program is being run, for example, it is determined that the user is seeing a display content that he/she does not want others to see (third use case) so that the display mode is automatically switched to the privacy protection mode M4. The display mode may be switched to the privacy protection mode M4 in a circumstance of use where a call line is actually connected with a voice calling application program run. Whether or not a display content should be protected for the security of privacy may be determined in accordance with whether or not the content is filtered by a so-called filtering function provided by a website, for example, in addition to whether or not the content has been registered in advance by the user.

### [Flow of Display Control According to Display Mode (Automatic Setting to Privacy Protection Mode)]

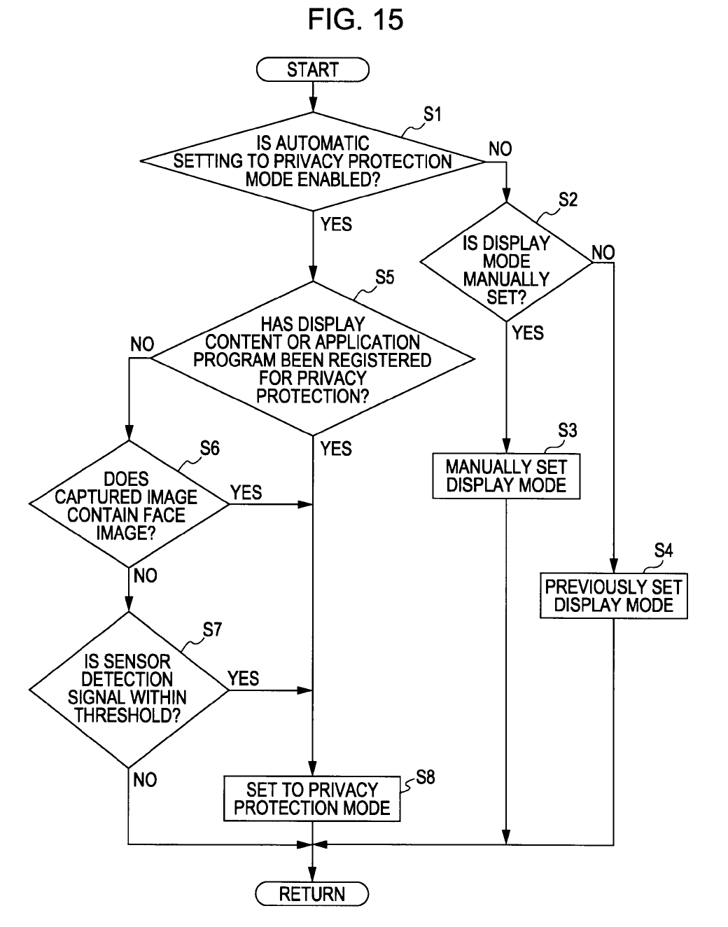

FIG. 15 is an exemplary flowchart of a process for automatically setting the display mode to the privacy protection mode in accordance with the results of the determination as to the various use cases described above. The process of FIG. 15 is performed when a control section 40 executes a display control program according to the present invention.

In FIG. 15, the control section 40 starts the display control program according to the present invention when any information is to be displayed on a display screen, for example.

During execution of the display control program, the control section 40 determines in step S1 whether or not the user has enabled automatic setting of the display mode to the privacy protection mode in the cellular phone terminal according to the embodiment. If the control section 40 determines in step S1 that automatic setting to the privacy protection mode is enabled, the process proceeds to step S5. On the other hand, if it is determined that automatic setting to the privacy protection mode is not enabled, the process proceeds to step S2. Even if it is determined that automatic setting to the privacy protection mode is enabled, the process may proceed to step S2 in the case where the user explicitly issues a command for shifting to a manual setting mode, for example. Conversely, even if it is determined that automatic setting to the privacy protection mode is not enabled, the process may proceed to step S5 in the case where the user explicitly issues a command for shifting to an automatic setting mode, for example.

In the case where it is determined in step S1 that automatic setting to the privacy protection mode is not enabled and the process proceeds to step S2, the control section 40 determines whether or not the user has manually set the display mode through the keypad 75 or the like.

If it is determined in step S2 that the display mode is manually set, the control section 40 causes the control signal generators 10A and 10B to generate a control signal for setting the display mode set by the user in step S3. After step S3, the control section 40 returns to the beginning of the process.

On the other hand, if it is determined in step S2 that the display mode is not manually set, the control section 40 maintains the previously set display mode in step S4. After step S4, the control section 40 returns to the beginning of the process.

In the case where it is determined in step S1 that automatic setting to the privacy protection mode is enabled and the process proceeds to step S5, the control section 40 determines whether or not the display content being currently displayed on the display has been registered as a content to be protected for the security of privacy, whether or not the application program being run has been registered as an application program that may display a content to be protected for the security of privacy, or the like. If it is determined that privacy protection should be performed, the control section 40 proceeds to step S8. On the other hand, if it is determined that the necessity of privacy protection is not registered, the control section 40 proceeds to step S6.

In step S6, the control section 40 causes the main camera device (25, 60) to capture an image and determines whether or not a face image of a person is recognized in the image. If a face image is recognized, the process proceeds to step S8. If a face image is not recognized, the process proceeds to step S7.

In step S7, the control section 40 compares a detection signal generated by the electrostatic sensor (46), the proximity sensor (23, 47), the temperature sensor (48), or the infrared ray sensor (29, 49) described above with a threshold determined in advance as described above. If it is determined from the results of the comparison between the detection signal and the threshold that the user is engaged in a call or that a person stays on the housing back surface side of the cellular phone terminal, the process proceeds to step S8. In other cases, the control section 40 returns to the beginning of the process.

In step S8, the control section 40 causes the control signal generators 10A and 10B to generate a control signal for setting the display mode to the display mode (privacy protection mode) M4 described above. After step S8, the control section 40 returns to the beginning of the process.

### CONCLUSION

According to the cellular phone terminal of the embodiment described above, a polymer-scattered liquid crystal usable as a transparent display and a shutter liquid crystal equipped with a mirror function which is the most effective in improving the viewability are combined with each other to form a display device shown in FIG. 6, and the display device is controlled so as to be driven in accordance with the display modes of FIG. 7 described above.

Thus, specifically in the display mode M4, it is possible to prevent what is displayed on the polymer-scattered liquid crystal from being seen by others from the back surface side while improving the viewability of the polymer-scattered liquid crystal for easy recognition by the user.

Also, the cellular phone terminal according to the embodiment allows automatic setting of the display mode. Therefore, what is displayed on the display is not seen by others, which protects the secrecy of the display content.

According to the embodiment, in addition, the bonding sheet layer described above is provided between the polymer-scattered liquid crystal and the shutter liquid crystal, which eliminates a loss of light and prevents deterioration of the transmittance and the viewability.

The embodiment described above is merely illustrative of the present invention. It is therefore a matter of course that the present invention is not limited to the embodiment described above and may be modified in various ways in design or the like without departing from the technical spirit of the present invention.

For example, the polymer-scattered liquid crystal described above may be replaced with a so-called STN (Super Twisted Nematic) liquid crystal or an organic EL (Electro Luminescent), for example. While the liquid crystals become transparent when voltage application is turned on in the embodiment described above, a liquid crystal that becomes transparent when voltage application is turned off may also be used. In this case, “ON” and “OFF” in FIG. 7 are reversed.

The bonding sheet layer is not limited to that used in the embodiment, and may be formed from a liquid ultraviolet-curable resin by irradiating the ultraviolet-curable resin with ultraviolet rays to cure the ultraviolet-curable resin, for example. That is, the bonding sheet layer may be formed from any material that eliminates an air layer between the polymer-scattered liquid crystal and the shutter liquid crystal. It is desirable, however, that the refractive index of the material forming the bonding sheet layer should be the same as or very close to the refractive index of the material forming the transparent plate material layer 3 and the polarization plate layer 5.

In the embodiment described above, the sensors perform detecting operations at all times. However, the sensors may start detecting operations only when an application program determined in advance such as a voice calling application program or a browser application program is executed, for example. In this case, the sensors are activated only when the application program is executed and do not function when the application program is not executed, which reduces the power consumption.

The present application contains subject matter related to that disclosed in Japanese Priority Patent Application JP 2009-211976 filed in the Japan Patent Office on Sep. 14, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display section including a transparent scattering layer switchable in accordance with a first control signal between a state in which incident light is transmitted in units of dots and a state in which incident light is scattered in units of dots, a transparent reflective layer switchable in accordance with a second control signal between a state in which incident light is transmitted and a state in which incident light is reflected, and a bonding layer that bonds the transparent scattering layer and the transparent reflective layer to each other; and
a control signal generation section configured to generate the first and second control signals.

2. The display apparatus according to claim 1,
wherein the transparent scattering layer includes a polymer-scattered liquid crystal layer in which a plurality of liquid crystal molecules corresponding to the respective dots are arranged in a matrix, and two transparent plate material layers sandwiching the polymer-scattered liquid crystal layer and including an electrode that supplies the first control signal to the respective liquid crystal molecules, the first control signal causing an axis of a desired liquid crystal molecule to be oriented in a direction of scattering incident light or to be oriented in a direction of allowing incident light to pass through, and
the transparent reflective layer includes a shutter liquid crystal layer in which a plurality of liquid crystal molecules are arranged in a matrix, two transparent plate material layers sandwiching the shutter liquid crystal layer and including an electrode that supplies the second control signal to the respective liquid crystal molecules, a polarization plate layer disposed on an outer side of one of the transparent plate material layers, and a reflective polarization film layer disposed on an outer side of the other of the transparent plate material layers, the second control signal causing a polarization direction of all the liquid crystal molecules for incident light to be aligned with a specific direction that allows incident light to pass through the polarization plate layer and the reflective polarization film layer or to be aligned with a direction different from the specific direction.

3. A portable information terminal comprising:
a display section including a transparent scattering layer switchable in accordance with a first control signal between a state in which incident light is transmitted in units of dots and a state in which incident light is scattered in units of dots, a transparent reflective layer switchable in accordance with a second control signal between a state in which incident light is transmitted and a state in which incident light is reflected, and a bonding layer that bonds the transparent scattering layer and the transparent reflective layer to each other, the transparent scattering layer and the transparent reflective layer being provided on a front surface side and a back surface side, respectively, of the terminal;
a circumstance determination section configured to determine a circumstance of use of the terminal; and
a control signal generation section configured to generate the first and second control signals in accordance with results of determination of the circumstance of use of the terminal performed by the circumstance determination section.

4. The portable information terminal according to claim 3,
wherein the transparent scattering layer includes a polymer-scattered liquid crystal layer in which a plurality of liquid crystal molecules corresponding to the respective dots are arranged in a matrix, and two transparent plate material layers sandwiching the polymer-scattered liquid crystal layer and including an electrode that supplies the first control signal to the respective liquid crystal molecules, the first control signal causing an axis of a desired liquid crystal molecule to be oriented in a direction of scattering incident light or to be oriented in a direction of allowing incident light to pass through, and
the transparent reflective layer includes a shutter liquid crystal layer in which a plurality of liquid crystal molecules are arranged in a matrix, two transparent plate material layers sandwiching the shutter liquid crystal layer and including an electrode that supplies the second control signal to the respective liquid crystal molecules, a polarization plate layer disposed on an outer side of one of the transparent plate material layers, and a reflective polarization film layer disposed on an outer side of the other of the transparent plate material layers, the second control signal causing a polarization direction of all the liquid crystal molecules for incident light to be aligned with a specific direction that allows incident light to pass through the polarization plate layer and the reflective polarization film layer or to be aligned with a direction different from the specific direction.

5. The portable information terminal according to claim 4,
wherein the circumstance determination section includes a camera section that captures an image from the back surface side of the terminal, and determines whether or not the image captured by the camera section contains a face image of a person, and
when the circumstance determination section determines that the captured image contains a face image of a person, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

6. The portable information terminal according to claim 4,
wherein the circumstance determination section includes an infrared ray sensor section provided on the back surface side of the terminal, and determines whether or not the infrared ray sensor section detects an infrared ray emitted from a human body, and
when the circumstance determination section determines that an infrared ray emitted from a human body is detected, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

7. The portable information terminal according to claim 4,
wherein the circumstance determination section includes an electrostatic sensor section provided on the front surface side of the terminal, and determines whether or not the electrostatic sensor section detects a contact with a human body, and
when the circumstance determination section determines that a contact with a human body is detected, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

8. The portable information terminal according to claim 4,
wherein the circumstance determination section includes a proximity sensor section provided on the front surface side of the terminal, and determines whether or not a distance from an object detected by the proximity sensor section is within a specific distance, and
when the circumstance determination section determines that the detected distance from an object is within the specific distance, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

9. The portable information terminal according to claim 4,
wherein the circumstance determination section includes a temperature sensor section provided on the front surface side of the terminal, and determines whether or not the temperature sensor section detects a human body temperature, and
when the circumstance determination section determines that a human body temperature is detected, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

10. The portable information terminal according to claim 4,
wherein the circumstance determination section determines whether or not a content determined in advance is displayed on the display section, and
when the circumstance determination section determines that the content determined in advance is displayed, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

11. The portable information terminal according to claim 4,
wherein the circumstance determination section determines whether or not an application program determined in advance is executed on the terminal, and
when the circumstance determination section determines that the application program determined in advance is executed, the control signal generation section generates the first control signal that causes the axis of a desired liquid crystal molecule of the polymer-scattered liquid crystal layer to be oriented in the direction of scattering incident light and the second control signal that causes the polarization direction of all the liquid crystal molecules of the shutter liquid crystal layer to be aligned with a direction different from the specific direction.

12. A display control method for a portable information terminal, comprising the steps of:
a circumstance determination section determining a circumstance of use of the portable information terminal; and
a control signal generation section generating first and second control signals for a display section in accordance with results of determination of the circumstance of use of the terminal performed by the circumstance determination section, the display section including a transparent scattering layer switchable in accordance with the first control signal between a state in which incident light is transmitted in units of dots and a state in which incident light is scattered in units of dots, a transparent reflective layer switchable in accordance with the second control signal between a state in which incident light is transmitted and a state in which incident light is reflected, and a bonding layer that bonds the transparent scattering layer and the transparent reflective layer to each other, the transparent scattering layer and the transparent reflective layer being provided on a front surface side and a back surface side, respectively, of the portable information terminal.

13. A display control program for causing a portable information terminal to execute:
a circumstance determination process for determining a circumstance of use of the portable information terminal; and
a control signal generation process for generating first and second control signals for a display section in accordance with results of determination of the circumstance of use of the terminal performed in the circumstance determination process, the display section including a transparent scattering layer switchable in accordance with the first control signal between a state in which incident light is transmitted in units of dots and a state in which incident light is scattered in units of dots, a transparent reflective layer switchable in accordance with the second control signal between a state in which incident light is transmitted and a state in which incident light is reflected, and a bonding layer that bonds the transparent scattering layer and the transparent reflective layer to each other, the transparent scattering layer and the transparent reflective layer being provided on a front surface side and a back surface side, respectively, of the portable information terminal.
